(19) United States
(12) Patent Application Publication
(10) Pub. No.: US 2005/0003951 A1
(43) Pub. Date: Jan. 6, 2005

(54) Porous polymers of propylene

(76) Inventors: Angelo Ferraro, Bologna (IT); Giovanni Baruzzi, Ferrara (IT); Constantine A Stewart, Albuquerque, NM (US)

Correspondence Address: BASELL USA INC., INTELLECTUAL PROPERTY, 912 APPLETON ROAD, ELKTON, MD, 21921, US

(21) Appl. No.: 10/496,995

(22) PCT Filed: Nov. 26, 2002
(86) PCT No.: PCT/EP02/13471

(30) Foreign Application Priority Data
Nov. 27, 2001 (EP) 01204694.2

(51) Int. Cl. C08F 4/02; C08F 4/60

(52) U.S. Cl. 502/102

(57) ABSTRACT

A porous polymer of propylene optionally containing up to 15% by weight of an alpha-olefins of formula CH₂═CHR wherein R is a hydrogen atom or a C₂-C₁₀ alkyl radical having the following characteristics: a) in the Temperature Rising Elution Temperature analysis (TREF) a fraction eluted at a temperature range front 25° C. to 97° higher than 20% of the total polymer eluted; and b) a pore volume (determined by mercury absorption) greater than 0.45 cc/g.

The present invention relates to porous propylene polymers having enhanced properties, especially when used as support for catalyst systems for the polymerization of olefins. Catalyst components for the polymerization of olefins comprising a titanium compound supported on a magnesium halide in active form can be obtained in spherical particle form suitable for the manufacture of polymers with optimum morphological characteristics. Components of this type are described in U.S. Pat. No. 3,953,414 and U.S. Pat. No. 4,399,054. Specifically, the polymers obtained with the catalysts of U.S. Pat. No. 4,399,054 are in spherical particle form having high flowability and bulk density values. The porosity (about 10% expressed in percentage of voids) and the surface area, however, are not sufficiently high for some industrial use. U.S. Pat. No. 5,236,962 relates to crystalline propylene polymers having high porosity. When used as support for a catalyst system for the polymerization of the olefins the activities of the resulting catalyst are not quite satisfactory. Therefore it is desirable to find new porous polymers that, when used as support, can improve the activity of the resulting catalyst systems. Thus, according to a first object, the present invention provides a porous,.polymer of propylene, optionally containing up to 15% by weight of an alpha-olefin of formula CH₂═CHR wherein R is a hydrogen atom or a C₂-C₁₀ alkyl radical, said porous propylene polymer having the following characteristics:
a) in the Temperature Rising Elution Temperature analysis (TREF) a fraction eluted at a temperature range of from 25° C. to 97° higher then 20% preferably higher than 30%; more preferably higher than 40% of the total polymer eluted; and
b) a pore volume (determined by mercury absorption) greater than 0.45 cc/g; preferably greater than 0.50 cc/g; more preferably greater than 0.55 cc/g.

In a particular embodiment the porous propylene polymer object of the present invention is further characterized by a flexural modulus (METHOD ASTM D-5023) lower than 1200 Mpa, preferably lower than 1000 Mpa, more preferably lower than 900 Mpa.

In another particular embodiment the porous polymer of the present invention has a melting enthalpy lower than 90 J/g; preferably lower than 80 J/g; more preferably lower than 70 J/g. In a suitable embodiment the polymer of the present invention is an homopolymer of propylene.

The polymer of the present invention has a high content of the so-called stereoblocks, i.e. of polymer fractions which, although predominantly isotactic, contain a not negligible amount of non-isotactic sequences of propylene units. In the conventional fractionation techniques such as the TREF (Temperature Rising Elution Temperature) those fractions are eluted at temperatures lower than those necessary for the more isotactic fractions. Due to the particular morphology, the propylene polymers of the present invention are particularly suitable as inert support for catalyst component used in the polymerization of olefins.

Examples of catalyst components that can be supported on the propylene polymer object of the present invention are the metallocene compounds such as those described in WO 98/22486, WO 99/58539 WO 99/24446, U.S. Pat. No. 5,556,928, WO 96/22995, EP-485822, EP-485820, U.S. Pat. No. 5,324,800, EP-A-0 129 368 EP-A-0 416 815, EP-A-0 420 436, EP-A-0 671 404, EP-A-0 643 066 and WO-A-91/04257. Thus a further object of the present invention is a heterogeneous catalyst system comprising:
A) a porous polymer of propylene according to the present invention;
B) a metallocene compound; and
C) an alumoxane or a compound able to form an alkylmetallocene cation.

Examples of metallocene compounds that can be used in the heterogeneous catalyst system of the present invention belongs to the following formula (I)
(Cp)(ZR¹ₘ)ₙ(A)ᵣMXₚ (1)
wherein (ZR¹ₘ)ₙ is a divalent group bridging Cp and A; Z being C, Si, Ge, N or P, and the R¹ groups, equal to or different from each other, being hydrogen or linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl groups or two R¹ can form a aliphatic or aromatic C₄-C₇ ring;
Cp is a substituted or unsubstituted cyclopentadienyl group, optionally condensed to one or more substituted or unsubstituted, saturated, unsaturated or aromatic rings, containing from 4 to 6 carbon atoms, optionally containing one or more heteroatoms;
A is O, S, NR², PR² wherein R² is hydrogen, a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl or A has the same meaning of Cp; M is a transition metal belonging to group 4, 5 or to the lanthanide or actinide groups of the Periodic Table of the Elements (IUPAC version);
the substituents X, equal to or different from each other, are monoanionic sigma ligands selected from the group consisting of hydrogen, halogen, R³, OR³, OCOR³, SR³, NR³₂ and PR³₂, wherein R³ is a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl group, optionally containing one or more Si or Ge atoms; preferably, the substituents X are the same; m is 1 or 2, and more specifically it is 1 when Z is N or P, and it is 2 when Z is C, Si or Ge; n is an integer ranging from 0 to 4; r is 0, 1 or 2; preferably 0 or 1; n is 0 when r is 0 or 2; p is an integer equal lo the oxidation state of the metal M minus r+1; it ranges from 1 to 4;

The alumoxanes used in the catalyst according to the invention are considered to be linear, branched or cyclic compounds containing at least one group of the type: 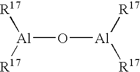
wherein the substituents R¹⁷, same or different, are described above.

In particular, alumoxanes of the formula: 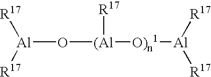
can be used in the case of linear compounds, wherein n¹ is 0 or an integer from 1 to 40 and the substituents R¹⁷ are defined as above, or alumoxanes of the formula: 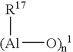
can be used in the case of cyclic compounds, wherein n¹ is an integer from 2 to 40 and the R¹⁷ substituents are defined as above. Examples of alumoxanes suitable for use according to the present invention are methylalumoxane (MAO), tetra-(isobutyl)alumoxane (TIBAO), tetra-(2,4,4-trimethyl-pentyl)alumoxane (TIOAO), tetra-(2,3-dimethylbutyl)alumoxane (TDMBAO) and tetra-(2,3,3-trimethylbutyl)alumoxane (TTMBAO). Particularly interesting cocatalysts are those described in WO 99/21899 and in WO01/21674 in which the alkyl and aryl groups have specific branched patterns. Non-limiting examples of aluminium compounds according to WO 99/21899 and WO/0121674 are:
tris(2,3,3-trimethyl-butyl)aluminium, tris(2,3-dimethyl-hexyl)aluminium, tris(2,3-dimethyl-butyl)aluminium, tris(2,3-dimethyl-pentyl)aluminium, tris(2,3-dimethyl-heptyl)aluminium, tris(2-methyl-3-ethyl-pentyl)aluminium, tris(2-methyl-3-ethyl-hexyl)aluminium, tris(2-methyl-3-ethyl-heptyl)aluminium, tris(2-methyl-3-propyl-hexyl)aluminium, tris(2-ethyl-3-methyl-butyl)aluminium, tris(2-ethyl-3-methyl-pentyl)aluminium, tris(2,3-diethyl-pentyl)aluminium, tris(2-propyl-3-methyl-butyl)aluminium, tris(2-isopropyl-3-methyl-butyl)aluminium, tris(2-isobutyl-3-methyl-pentyl)aluminium, tris(2,3,3-trimethyl-pentyl)aluminium, tris(2,3,3-trimethyl-hexyl)aluminium, tris(2-ethyl-3,3-dimethyl-butyl)aluminium, tris(2-ethyl-3,3-dimethyl-pentyl)aluminium, tris(2-isopropyl-3,3-dimethyl-butyl)aluminium, tris(2-trimethylsilyl-propyl)aluminium, tris(2-methyl-3-phenyl-butyl)aluminium, tris(2-ethyl-3-phenyl-propyl)aluminium, tris(2,3-dimethyl-3-phenyl-butyl)aluminium, tris(2-phenyl-propyl)aluminium, tris[2-(4-fluoro-phenyl)-propyl]aluminium, tris[2-(4-chloro-phenyl)-propyl]aluminium, tris[2-(3-isopropyl-phenyl)-propyl]aluminium, tris(2-phenyl-butyl)aluminium, tris(3 -methyl-2-phenyl-butyl)aluminium, tris(2-phenyl-pentyl)aluminium, tris[2-(pentafluorophenyl)-propyl]aluminium, tris[2,2-diphenyl-ethyl]aluminium and tris[2-phenyl-2-methyl-propyl]aluminium, as well as the corresponding compounds wherein one of the hydrocarbyl groups is replaced with a hydrogen atom, and those wherein one or two of the hydrocarbyl groups are replaced with an isobutyl group.

Amongst the above aluminium compounds, trimethylaluminium (TMA), triisobutylaluminium (TIBAL), tris(2,4,4-trimethyl-pentyl)aluminium (TIOA), tris(2,3-dimethylbutyl)aluminium (TDMBA) and tris(2,3,3-trimethylbutyl)aluminium (TTMBA) are preferred. Non-limiting examples of compounds able to form an alkylmetallocene cation that can be used as component (B) are compounds of formula D⁺E⁻, wherein D⁺ is a Bronsted acid, able to donate a proton and to react irreversibly with a substituent X of the metallocene of formula (I) and E⁻ is a compatible anion, which is able to stabilize the active catalytic species originating from the reaction of the two compounds, and which is sufficiently labile to be able to be removed by an olefinic monomer. Preferably, the anion E⁻ comprises of one or more boron atoms. More preferably, the anion E³¹ is an anion of the formula BAr₄⁽⁻⁾, wherein the substituents Ar which can be identical or different are aryl radicals such as phenyl, pentafluorophenyl or bis(trifluoromethyl)phenyl. Tetrakis-pentaflurophenyl borate is particularly preferred examples of these compounds are described in WO 91/02012. Moreover, compounds of the formula BAr₃ can conveniently be used. Compounds of this type are described, for example, in WO 92/00333. Other examples of compounds able to form an alkylmetallocene cation are compounds of formula BAr₃P wherein P is a substituted or unsubstituted pyrrol radicals, and B is a boron atom. These compounds are described in WO/0162764. All these compounds containing boron atoms can be used in a molar ratio between boron and the metal of the metallocene comprised between about 1:1 and about 10:1; preferably 1:1 and 2.1; more preferably about 1:1.

Non limiting examples of compounds of formula D⁺E⁻ are:
Triethylammoniuimtetra(phenyl)borate,
Tributylammoniumtetra(phenyl)borate,
Trimethylammoniumtetra(tolyl)borate,
Tributylammoniumtetra(tolyl)borate,
Tributylammnoniumtetra(pentafluorophenyl)borate,
Tributylammoniumtetra(pentafluorophenyl)aluminate,
Tripropylammoniumtetra(dimethylphenyl)borate,
Tributylammoniumtetra(trifluoromethylphenyl)borate,
Tributylammoniumtetra(4-fluorophenyl)borate,
N,N-Dimethylaniliniumtetra(phenyl)borate,
N,N-Diethylaniliniumtetra(phenyl)borate,
N,N-Diethylaniliniumtetrakis(pentafluorophenyl)boratee,
N,N-Dimethylaniliniumtetrakis(pentafluorophenyl)aluminate,
Di(propyl)amnmoniumtetrakis(pentafluorophenyl)borate,
Di(cyclohexyl)ammoniumtetrakis(pentafluorophenyl)borate,
Triphenylphosphoniumtetrakis(phenyl)borate,
Triethylphosphoniumtetrakis(phenyl)borate,
Diphenylphosphoniurntetrakis(phenyl)borate,
Tri(methylphenyl)phosphoniumtetrakis(phenyl)borate,
Tri(dimethylphenyl)phosphoniumtetrakis(phenyl)borate,
Triphenylcarbeniumtetrakis(pentafluorophenyl)borate,
Triphenylcarbeniumtetrakis(pentafluorophenyl)aluminate,
Triphenylcarbeniumtetrakis(phenyl)aluminate,
Ferroceniumtetrakis(pentafluorophenyl)borate,
Ferroceniumtetrakis(pentafluorophenyl)aluminate.
Triphenylcarbeniumtetrakis(pentafluorophenyl)borate,
N,N-Dimethylaniliniumtetrakis(pentafluorophenyl)borate.

Further compounds that can be used are those of formula RM′-O-M′R, R being an alkyl or aryl group. and M′ is selected from an element of the Group 13 of the Periodic Table of the Elements (new IUPAC version). Compounds of this type are described, for example, in the International patent application WO 99/40129.

Due to the particular stereoblock structure, the polymer of the present invention can also be used as component in a blend such as TPOs or other kind of heterophasic polymers blends. It can also form the isotactic polypropylene matrix produced in the first step of a multistep process for the production of reactor blends, such as the processes described in EP 720629 and EP 742801. Thus a further aspect of the present invention is a blend containing from 0.1% to 99.9% by weight of the porous polymer object of the present invention and from 0.1% to 99% by weight of one or more polymers, preferably one or more alpha-olefin polymers. Preferably the blend contains from 10% to 60% by weight, more preferably from 20% to 50% by weight of the porous polymer object of the present invention.

The polymers object of the present invention can be prepared by using catalyst components having particular morphological properties, obtained from adducts of magnesium chloride with alcohols containing generally 3 moles of alcohol per mole of MgCl₂, which are prepared by emulsifying, in the molten state, the adduct in an inert hydrocarbon liquid immiscible with the melted adduct, then cooling the emulsion very rapidly in order to cause the solidification of the adduct in the form of spherical particles. The resultant particles are then subjected to partial dealcoholation using a heating cycle at temperature increasing from 50° C. to 130° C. until the alcohol content is decreased from 3 to about 0.5-1.5 moles per mole of MgCl₂. The adduct thus obtained is suspended cold in TiCl₄, at a concentration of 40-50 g/l, and then brought to a temperature of 80° C. to 135° C. where it is maintained for 1-2 hours. To this TiCl₄ is also added an electron-donor compound. The internal electron-donor compounds can be selected from ethers, esters, amines, ketones and the like. Non-limiting examples are alkyl esters, cycloalkyls and aryls of polycarboxylic acids, such as phthalic and maleic esters and ethers, such as those described in EP-A 45977, the disclosure of which is incorporated herein by reference. Preferably electron donor include mono or disubstituted phthalates wherein the substituents is a linear or branched C₁₋₁₀ alkyl, C₃₋₈ cycloalkyl, or aryl radical, such as for instance diisobutyl, di-n-butyl, and di-n-octyl phthalate. The excess TiCl₄ is then removed hot through filtration or sedimentation, and the treatment with TiCl₄ is repeated one or more times. The resulting solid is then washed with heptane or hexane and then dried. The catalyst component obtained is endowed with the following characteristics:
surface area up 100 m²/g; preferably the surface area is comprised between 60 and 80 m²/g;
porosity (nitrogen) comprised between 0.25 and 0.35 cc/g;
porosity (Hg) comprised between 0.5 and 1 cc/g with the exclusion of macropores (pores having diameter >10000 ); and
more than 50% of the pores have a radius greater than 100 angstrom.

The catalyst is obtained by mixing the solid catalyst component with an aluminum trialkyl compound, preferably aluminum triethyl or aluminum triisobutyl, and an electron donor compound (external donor).

The external donor preferably used has formula (I) or (II): 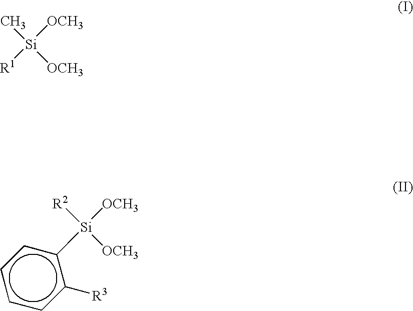
wherein
R¹ is a linear C₄-C₂₀ alkyl radical; preferably R¹ is a linear C₄-C₁₀ alkyl radical such as butyl, hexyl octyl or decil radical;
R² is a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl radical; preferably R² is a linear C₁-C₂₀ alkyl radical such as methyl, ethyl, propyl butyl, hexyl octyl or decil radical;
R³ is a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl radical optionally containing heteroatoms of group 13-16 of the periodic table; preferably R³ is a linear C₁-C₄ alkyl or C₁-C₂₀ alkoxy radical. The Al/Ti ratio is generally from 10 to 800 and the molar silane/Al ratio is typically from ⅕ to 1/50. The (co)polymerization of propylene is done according to known techniques operating in liquid monomer or gas phase. The polymerization temperature is generally from 0° C. to 100° C., preferably from 30° C. to 90° C., more preferably from 70° C. to 90° C. The catalysts can be precontacted with small quantities of olefin (prepolymerization), maintaining the catalyst in suspension in a hydrocarbon solvent, polymerizing at a temperature between room temperature and 60° C. for a time sufficient to produce quantities of polymer from 0.5 to 3 times the weight of the catalyst.

Prepolymnerization in a monomer liquid can also be done, producing in this case quantities of polymer up to 1000 times the weight of the catalyst. The polymer of the present invention can be used as inert support for a catalyst component in a process for the polymerization of olefins. The polymer of the present invention can be used, for example, by adding to a suspension in propane of the porous polymer a solution or a suspension of the catalyst system, under stirring. Then the propane is removed, for example, by flashing the solution thus obtaining the supported catalyst.

### EXAMPLES

General Procedures

The data shown in the Examples relative to the properties of the porous polymers of the present invention were determined according to the methods indicated below.
MIL flow index: ASTM-D 1238
Intrinsic viscosity (I.V.): measured in tetrahydronaphtalene (THN) at 135° C.
   Fraction Soluble in Xylene:

2 g of polymer were dissolved in 250 ml of xylene at 135° C. under stirring. After 20 minutes the solution was left to cool, still under stirring, up to 25° C. After 30 minutes the precipitated material was filtered through filter paper, the solution was evaporated in nitrogen current and the residual was dried under vacuum al 80° C. until it reached constant weight. Thus, the percentage of polymer soluble in xylene at room temperature was calculated.

Porosity (Mercury):

determined by immersing a known quantity of the sample in a known quantity of mercury inside a dilatometer and gradually hydraulically increasing the pressure of the mercury. The pressure of introduction of the mercury in the pores is in function of the diameter of the same. The measurement was carried out using a porosimeter “Porosimeter 2000 Series” (C. Erba). The total porosity was calculated from the volume decrease of the mercury and the values of the pressure applied. The porosity expressed as percentage of voids is determined by absorption of mercury under pressure. The volume of mercury absorbed corresponds to the volume of the pores. For this determination, a calibrated dilatometer (diameter 3 mm) CD3 (Carlo Erba) connected to a reservoir of mercury and to a high-vacuum pump (1.10-2 mbar) is used. A weighed amount of sample (about 0.5 g) is placed in the dilatometer. The apparatus is then placed under high vacuum (<0.1 mm Hg) and is maintained in these conditions for 10 minutes. The dilatometer is then connected to the mercury reservoir and the mercury is allowed to flow slowly into it until it reaches the level marked on the dilatometer at a height of 10 cm. The valve that connects the dilatometer to the vacuum pump is closed and the apparatus is pressurised with nitrogen (2.5 Kg/cm²). Under the effect of the pressure, the mercury penetrates into the pores and the level goes down according to the porosity of the material. Once the level at which the mercury has stabilised has been measured on the dilatometer, the volume of the pores is calculated from the equation V=R2πΔH, where R is the radius of the dilatometer and ΔH is the difference in cm between the initial and the final levels of the mercury in the dilatometer. By weighting the dilatometer, dilatometer+mercury, dilatometer+mercury+sample, the value of the apparent volume V₁ of the sample prior to penetration of the pores can be calculated. The volume of the sample is given by:
V₁=[P₁−(P₂−P)]/D
P is the weight of the sample in grams, P₁ is the weight of the dilameter+mercury in grams,
P₂ is the weight of the dilatometer+mercury+sample in grams, D is the density of mercury (at 25° C.=13,546 g/cm). The percentage porosity is given by the relation:
   X=(100 V)/V₁.
Bulk density: DIN-53194.
Morphology: ASTM-D-1921-63.
Flexural modulus: ASTM D-5023.
Compression. Set: ASTM D395 22 hr/70° C.
Hardness Shore A: ASTM D2240.
Modulus 100, psi: ASTM D412.
Tensile strength: ASTM D412.
Elongation: ASTM D412.
Tension set: ASTM D412.
   Temperature Rising Elution Fractionation (TREF) Tecnigue:

carried out as described in EP 658 577.

### Example 1 (Comparative)

The solid titanium catalyst component was prepared according to example 2 of EP-A-395 083.

Using 0.011 g of this solid, a propylene polymerization was carried out in a 4 l autoclave equipped with magnetically driven stirrer and a thermostatic system, previously fluxed with nitrogen at 70° C. for one hour and then with propylene. Into the reactor at room temperature, without stirring but under propylene stream, a catalyst system consisting of a suspension of the solid component in 15 ml of hexane, 1.14 g of triethylaluminiuim, and 114 mg of dicyclopentyldimethoxysilane (donor D) is introduced, this system is prepared just prior to its use in the polymerization test. The autoclave is then closed and 3 l of hydrogen are introduced. Under stirring, 1.3 Kg of propylene was charged and the temperature was brought to 70° C. in 5 minutes, maintaining the value constant for two hours. At the end of the test, the stirring was stopped and the unreacted propylene was vented off. After cooling the autoclave to room temperature, the polymer is recovered and then dried at 70° C. under a nitrogen stream in an oven for 3 hours. 418 g of spherical polymer. The characteristics of the polymer are reported in table 1.

### Example 2 (Comparative)

The solid titanium catalyst component was prepared according to example 2 of EP-A-395 083. A polymerization reactor was heated to 70° C., purged with a slow argon flow for 1 hour, its pressure was then raised to 100 psi-g with argon at 70° C. and then the reactor was vented. This procedure was repeated 4 more times. The reactor was then cooled to 30° C. Separately, into an argon purged addition funnel, the following were introduced,in the order thay are listed; 75 mL of hexane, 4.47 mL of 1.5 M solution of triethylaluminum (TEAL) (0.764 g 6.70 mmol) in hexane, approximately 0.340 mmol of dicyclopentyl dimetoxy silane (donor D) (TEAL/D about 20:1) and allowed to stand for 5 minutes. Of this mixture, 35 mL was added to a flask. Then 0.0129 of the catalyst component previously prepared was added to the flask and mixed by swirling for a period of 5 minutes. The catalytic complex so obtained was introduced, under an argon purge, into the polymerization reactor at room temperature. The remaining hexane/TEAL/silane solution was then drained from the additional funnel to the flask, the flask was swirled and drained into the reactor and the injection valve was closed. The polymerization reactor was slowly charged with 2.2. L of liquid propylene and H₂ while stirring. Then the reactor was heated to 70° C. maintaining the temperature and pressure constant for about 2 hours. After about two hours agitation was stopped and the remaining propylene was slowly vented. The reactor was heated to 80° C., pured with argon for 10 minutes and then cooled to room temperature and opened. The polymer was removed and dried in a vacuum oven at 80° C. for 1 hour.

The characteristics of the polymer are reported in table 1.

### Example 3

The procedure for the preparation of the polymer of example 2 was followed excepting that butylmethyldimetoxy silane (BuMeMS) was used as external donor instead of dicyclopentyl dimetoxy silane.

The characteristics of the polymer are reported in table 1.

### Example 4

The procedure for the preparation of the polymer of example 2 was followed excepting that Octilmethyldimetoxy silane (OctMeMS) was used as external donor instead of dicyclopentyl dimetoxy silane.

The characteristics of the polymer are reported in table 1.

### Polymerization Examples 5-8

The amount of polypropylene as described in table 2 were charged into a reactor of 4 L of capacity, under propane atmosphere (pressure 1 bar), at room temperature, without any stirring. 250 g of propane were added at room temperature under stirring (a pressure of about 10 bar was achieved). 4.4 g of 5-ethylidene-2-norbornene (ENB) were added thereafter, by a little nitrogen overpressure, under stirring at room temperature for 10 minutes and then propane was flashed under stirring. 250 g of propane were then added at room temperature under stirring and the temperature was brought to 40° C. In the meantime, rac-ethylenbis (tetrahydroindenyl)ZrCl₂ (rac EBTHIZrCl₂), methyl alumoxane (MAO) and Al(isooctyl)₃(TIOA) were dissolved in 10 ml of toluene at room temperature for ten minutes (amounts reported in table 2). The catalyst solution was then injected into the reactor by a little nitrogen overpressure. The suspension in the reactor was stirred at 40° C. for 10 minutes. Then the reactor was vented. Propane was added thereto, to achieve a pressure of 6 bar-g at 30° C. A 50/50 ethylene/propylene mixture was fed to the reactor, in 5 minutes, bringing the pressure to 20 bar-g and the temperature to 60° C. During the whole course of the polymerisation the temperature was kept constant at 60° and the pressure too was maintained constant at 20 bar-g by continuously feeding an ethylene/propylene mixture in a 60/40 wt/wt ratio. During the polymerisation 16 ml of a pentane solution containing an amount of ENB reported in table 1 was continuously added dropwise.

The polymerisation was stopped by quickly degassing the monomers. The polymer was plunged in 800 ml of methanol and filtered.

The filtered polymer was plunged again in 800 ml of methanol containing Irganox 1020, added to be about 200 ppm on the polymer.

Methanol was then evaporated with a nitrogen stream under reduced pressure at 60° C.

Polymerization data and characterization data of the obtained polymers are reported in table 2.

TABLE 1

| | | | | Bulk | flexural | melting | | Pore | Average | TREF |
|---|---|---|---|---|---|---|---|---|---|---|
| | H₂ | I.V. | XSRT | density | modulus | enthalpy | melting | volume | radius | 25-97° C. |
| Ex | Mol % | (dl/g) | % | g/cc | Mpa | J/g | point | cc/g | μm | % |
| 1* | n.a. | 1.49 | 3.50 | 0.36 | n.a. | n.a. | n.a. | 0.54 | 8.7 | n.a. |
| 2* | 0.15 | 2.12 | 3.35 | 0.29 | 1500 | 89 | 164.8 | 0.67 | 15 | 8.0 |
| 3 | 0.10 | 1.53 | 9.24 | 0.31 | 920 | 87 | 159.9 | 0.58 | 14 | 41.0 |
| 4 | 0.10 | 1.48 | n.a. | 0.30 | 830 | 106 | 159.8 | 0.66 | 15 | 40.3 |

n.a. = not available
*comparative

TABLE 2

| | | | | | | | | | | | Split | I.V. |
|---|---|---|---|---|---|---|---|---|---|---|---|---|
| | PP Ex | EBTHI | MAO | TIAO | | Diene | Time | Activity | ENB | ET | rubber | tot |
| Ex | (g) | mg | mmol | mmol | Al/Zr | g | min | Kg/gcat | % wt | % wt | % wt | (dl/g) |
| 5* | 1 (175) | 14 | 1.09 | 5.47 | 200 | 7.9 | 120 | 23.7 | 2.0 | 65 | 62 | 2.8 |
| 6* | 2 (150) | 14 | 1.09 | 5.47 | 200 | 9.7 | 55 | 22.5 | 2.5 | 61 | 68 | 2.0 |
| 7 | 3 (150) | 8 | 0.63 | 3.13 | 200 | 6.6 | 160 | 30.6 | 2.0 | 64 | 62 | 2.1 |
| 8 | 4 (150) | 8 | 0.63 | 3.13 | 200 | 8.36 | 110 | 37.5 | 2.3 | 61 | 68 | 2.0 |

*comparative

1. A porous polymer of propylene, optionally containing up to 15% by weight of an alpha-olefin of formula CH₂═CHR wherein R is a hydrogen atom or a C₂-C₁₀ alkyl radical, said porous propylene polymer having the following characteristics:
a) in the Temperature Rising Elution Temperature analysis (TREF) a fraction, eluted at a temperature range from 25° C. to 97°, being higher than 20% of the total polymer eluted; and
b) a pore volume (determined by mercury absorption) being greater than 0.45 cc/g.

2. The polymer according to claim 1 wherein the flexural modulus is lower than 1200 Mpa.

3. The polymer according to claim 1 wherein the porous polymer has a melting enthalpy lower than 90 J/g.

4. The polymer according to claim 1 wherein in the Temperature Rising Elution Temperature analysis (TREF) the fraction, eluted at a temperature range from 25° C. to 97°, is higher than 30% of the total polymer eluted.

5. The polymer according to claim 2 wherein the flexural modulus is lower than 1000 Mpa.

6. The polymer according to claim 1 wherein the pore volume (determined by mercury absorption) is greater than 0.50 cc/g.

7. A heterogeneous catalyst system comprising:
A) a porous polymer of propylene containing up to 15% by weight of an alpha-olefin of formula CH₂═CHR wherein R is a hydrogen atom or a C₂-C₁₀ alkyl radical having the following characteristics:
a) in the Temperature Rising Elution Temperature analysis (TREF) a fraction, eluted at a temperature range from 25° C. to 97°, being higher than 20% of the total polymer eluted; and
b) a pore volume (determined by mercury absorption) being greater than 0.45 cc/g;
B) a metallocene compound; and
C) an alumoxane or a compound that forms an alkylmetallocene cation.

8. A blend containing from 0.1% to 99.9% by weight of a porous polymer of propylene, optionally containing up, to 15% by weight of an alpha-olefin of formula CH₂═CHR wherein R is a hydrogen atom or a C₂-C₁₀ alkyl radical, said porous propylene polymer having the following characteristics:
a) in the Temperature Rising Elution Temperature analysis (TREF) a fraction, eluted at a temperature range from 25° C. to 97°, being higher than 20% of the total polymer eluted: and
b) a pore volume (determined by mercury absorption) being greater than 0.45 cc/g, and from 99.9% to 0.1% by weight of one or more polymers.

9. The blend according to claim 8 wherein the one or more polymers are one or more alpha-olefin polymers.
